(19) United States
(12) Patent Application Publication
(10) Pub. No.: US 2016/0125351 A1
(43) Pub. Date: May 5, 2016

(54) METHOD AND SYSTEM FOR DELIVERING POSTAL MAIL AUTOMATICALLY

(71) Applicant: Electronics and Telecommunications Research Institute, Daejeon (KR)

(72) Inventor: Moon Sung PARK, Daejeon (KR)

(21) Appl. No.: 14/630,175

(22) Filed: Feb. 24, 2015

(30) Foreign Application Priority Data
Nov. 4, 2014 (KR) 10-2014-0152310

(51) Int. Cl. G06Q 10/08

(52) U.S. Cl. CPC G06Q 10/083

(57) ABSTRACT

The present invention provides an unmanned postal mail delivering method, including: acquiring information of a sender who delivers a postal mail to a delivery box provided in an unmanned postal office; specifying the postal mail through information on a recipient of the postal mail and an address of the unmanned postal office and sending the postal mail to the postal office; sorting the postal mail together with a plurality of other postal mails of the postal office through the address to be included in a delivery quantity which will be delivered to a unmanned postal office; delivering the postal mail to the unmanned postal office; and receiving the postal mail by the recipient through authentication of information of the recipient.

### CROSS-REFERENCE TO RELATED APPLICATIONS

This application claims priority to and the benefit of Korean Patent Application No. 10-2014-0152310 filed in the Korean Intellectual Property Office on Nov. 4, 2014, the entire contents of which are incorporated herein by reference.

### TECHNICAL FIELD

The present invention relates to an unmanned postal mail delivering method and more particularly, to an unmanned postal mail delivering method which provides a postal mail sorting job and a delivery preparing method to deliver a postal mail to an unmanned post office, delivers a postal mail to a member/non-member, delivers a postal mail during one's absence, receives a postal mail, and provides a value-added services for a postal mail in a delivery box.

### BACKGROUND ART

Even though traffic of parcels is increased every year in accordance with tremendous increase of online trading such as Internet shopping, a work flow of a postal company is not fast enough to satisfy a request of a sender who wants to quickly send goods.

For example, in order to send a parcel, the sender selects a parcel delivery service company, requests the parcel delivery service company to collect the parcel wirely or via on-line and sends the parcel through a delivery man who visits the sender. Several hours or almost a day may be consumed until the delivery man visits the sender, which may vary depending on the parcel delivery service company. Further, when the delivery man visits the sender, parcel information such as an address to be delivered is input through a personal terminal such as a PDA or but mostly input by hand-writing by the delivery man and computerized to be input again in a collection terminal where parcels are collected later. In this case, when an error is caused during the input process by the delivery man or the computerizing process, the parcel may be sent in an erroneous location and the delivery may be delayed as much as the time for data processing.

Recently, in order to overcome the above-mentioned drawback, an unmanned device which allows the sender to directly send the parcel has been suggested, but the unmanned device which has been suggested in the related art has several problems. First, when a postal mail is delivered by the unmanned device using an image acquisition result, during a process of acquiring images using two or more cameras, errors are caused and lots of spaces for the cameras are required. Alternatively, a method for delivering a postal mail or an apparatus for controlling the postal mail is not specifically described in some cases and when a recipient receives the postal mail through a wireless terminal (for example, a cellular phone) which is possessed by the recipient, there may be a problem when the recipient cannot receive the postal mail due to loss of the cellular phone or a third party who is not the recipient obtains the cellular phone to access the postal mail. Further, when a delivery box is allocated to each individual and a postal mail will be additionally delivered to the same individual, there may be a problem in that the postal mail which has been delivered will be lost or stolen.

### SUMMARY OF THE INVENTION

The present invention has been made in an effort to provide an unmanned postal mail delivering method which applies a separate address system to an unmanned post office to easily prepare a delivery process and when an unmanned postal delivery box of a primary delivery address is insufficient, delivers the postal mail to a secondary or a third unmanned postal office or a deliverable address.

The present invention has been made in an effort to further provide an unmanned postal mail delivering method which may extend a storage period of a postal mail which is stored in an unmanned postal delivery box for a long period of time and requests to deliver the postal mail to a desired address to be redelivered to a recipient.

The present invention has been made in an effort to further provide an unmanned postal mail delivering method which does not need to separately register data for registering a delivery result, managing contents of a value-added service, and providing a reception result by a delivery man and a collection worker to save a communication cost for registering a postal mail processing result in the related art.

The present invention has been made in an effort to further provide an unmanned postal mail delivering method which does not have worrying whether the postal mail will be lost or stolen even when a plurality of postal mails is delivered to the same recipient and maximizes utilization of a delivery box to minimize an installation space, which may minimize an installation cost.

An exemplary embodiment of the present invention provides an unmanned postal mail delivering method, including: acquiring information of a sender who delivers a postal mail to a delivery box provided in an unmanned postal office; specifying the postal mail through information on a recipient of the postal mail and an address of the unmanned postal office and sending the postal mail to the postal office; sorting the postal mail together with a plurality of other postal mails of the postal office using the address to be included in a delivery quantity which will be delivered to an unmanned postal office; delivering the postal mail to the unmanned postal office; and receiving the postal mail by the recipient through authentication of information of the recipient.

In the exemplary embodiment, an address of the sending or receiving unmanned postal office may be configured by “N digit integer−M digit integer” and N and M may be natural numbers, the N digit integer may be a location number of a location where the sending or receiving unmanned postal office is provided and a control number and the M digit integer may be a membership number which is assigned to the sender through the client information managing unit.

In the exemplary embodiment, the acquiring of information of a sender may include: requesting an agreement to policy terms for using the unmanned postal office to the sender; inputting information of the sender: setting the unmanned postal office and selecting one or more other delivery locations except for the unmanned postal office; authenticating the sender through the information of the sender; acquiring information of a recipient of the postal mail; providing a membership number which is assigned to the sender to the sender; and registering the information of the sender and the membership number as membership data of senders who use the unmanned postal office.

In the exemplary embodiment, information of the sender and information of the recipient each may include at least one of information of a wireless terminal which is possessed by the sender and the recipient and an e-mail address.

In the exemplary embodiment, the method may further include providing a value-added service related with the postal mail to the sender or the recipient; and requesting payment for providing the value-added service, in which the value-added service includes at least one of extension of storage date of a postal mail delivered in the delivery box, a request to transmit the postal mail to another delivery location, a request to return the postal mail, and a request to provide an image of the postal mail.

In the exemplary embodiment, the delivering of the postal mail to the unmanned postal office may include: checking a usage status of a delivery box provided in the unmanned postal office to determine whether first delivery of the postal mail is available; delivering the postal mail to the unmanned postal office when the postal mail can be delivered as a result of determining whether the first delivery is available and searching for one or more other delivery locations except for the unmanned postal office when the delivery of the postal mail is unavailable; determining whether a second delivery of the postal mail to the other delivery location is available; delivering the postal mail to the other delivery location when the postal mail can be delivered as a result of the determining whether the second delivery is available and requesting the recipient or the sender to change the delivery location of the postal mail when the delivery of the postal mail is unavailable; and delivering the postal mail to the changed delivery location when the delivery location is changed and storing the postal mail in the postal office when the delivery location is not changed.

In the exemplary embodiment, the requesting of an approval to change the delivery location of the postal mail may include: requesting to change the delivery location of the postal mail through a wireless terminal and an e-mail of the recipient or the sender.

In the exemplary embodiment, the receiving of the postal mail by the recipient may include: determining whether there is a membership number of the unmanned postal office of the recipient; authenticating the recipient through the membership number when there is a membership number of the recipient and transmitting temporary ID and password for receiving the postal mail to the recipient and authenticating the recipient through the temporary ID and password when the recipient does not have a membership number; providing a quantity of the postal mail and a storage detail to the authenticated recipient; and selecting the delivery box where the postal mail is delivered and providing the postal mail to the recipient.

In the exemplary embodiment, the method may further include: after receiving of the postal mail by the recipient, identifying whether a door provided on the delivery box is closed and whether other postal mail is present in addition to the postal mail; deleting the information of the sender and the recipient when the door of the delivery box is closed and storing information indicating that the postal mail is received by the recipient; and notifying the recipient or a manager who manages the unmanned postal office that the door is open, when the door of the delivery box is not closed.

In the exemplary embodiment, the notifying that the door is open may include: notifying that the door of the delivery box is opened through a sender interface which is provided in the unmanned postal office after a predetermined first time has elapsed; notifying the recipient that the door is opened through a wireless terminal of the recipient after a predetermined second time has elapsed; and notifying the manager that the door is opened after a predetermined third time has elapsed, and among the first, second, and third times, the first time is the shortest time and the third time is the longest.

According to the present invention, an unmanned postal mail delivering method may apply a separate address system to an unmanned post office to easily prepare a delivery preparing process and when an unmanned postal delivery box of a primary delivery address is insufficient, deliver the postal mail to a secondary or third unmanned postal office or a deliverable address.

It is also possible to extend a storage period of a postal mail which is stored in an unmanned postal office delivery box for a long period of time and request to deliver the postal mail to a desired address to be redelivered to a recipient.

There is no need to separately register data for registering a delivery result, managing contents of a value-added service, and providing a reception result by a delivery man and a collection worker to save a communication cost for registering a postal mail processing result in the related art.

Even when a plurality of postal mails is delivered to the same recipient, there is no unnecessary worry whether the postal mails will be lost or stolen and utilization of a delivery box is maximized to minimize an installation space, which may minimize an installation cost.

### BRIEF DESCRIPTION OF THE DRAWINGS

FIG. 1 is a view illustrating a delivery box which is provided in an unmanned postal office which is used in an unmanned postal mail delivering method according to an exemplary embodiment of the present invention.

FIG. 2 is a view illustrating a postal code and an address of an unmanned postal office which is used in an unmanned postal mail delivering method according to an exemplary embodiment of the present invention.

FIG. 3 is a view illustrating an unmanned postal mail delivering method according to an exemplary embodiment of the present invention.

FIG. 4 is a view specifically illustrating a member joining step of a sender of an unmanned postal mail delivering method according to an exemplary embodiment of the present invention.

FIG. 5 is a view specifically illustrating a postal mail delivering step of an unmanned postal mail delivering method according to an exemplary embodiment of the present invention.

FIG. 6 is a view specifically illustrating a postal mail receiving step of an unmanned postal mail delivering method according to an exemplary embodiment of the present invention.

FIG. 7 is a view illustrating an unmanned postal mail delivering system according to another exemplary embodiment of the present invention.

FIG. 8 is a view specifically illustrating an unmanned postal mail delivering system according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Advantages and characteristics of the present invention, and a method of achieving the advantages and characteristics will be described by referring to exemplary embodiments described below in detail together with the accompanying drawings. As those skilled in the art would realize, the described embodiments may be modified in various different ways, all without departing from the spirit or scope of the present invention. The exemplary embodiments are provided to describe the technical spirit of the present invention in detail so as to be easily carried out by those skilled in the art.

In the drawings, the exemplary embodiments of the present invention are not limited to an illustrated specific example but may be exaggerated for clarity. Herein, specific terms have been used, but are just used for the purpose of describing the present invention and are not used for defining the meaning or limiting the scope of the present invention, which is disclosed in the appended claims.

Expression of “and/or” used in the specification is used to include at least one of the elements listed before and after the “and/or”. Further, when it is described that an element is “connected/coupled” to another element, the element may be directly coupled to the other element or indirectly coupled to the other element through a third element. Unless particularly stated otherwise in the present specification, a singular form also includes a plural form. The word “comprise” and variations such as “comprises” or “comprising” will be understood to imply presence or addition of one or more other components, steps, operations, and elements.

Hereinafter, exemplary embodiments of the present invention will be described in detail with reference to the drawings.

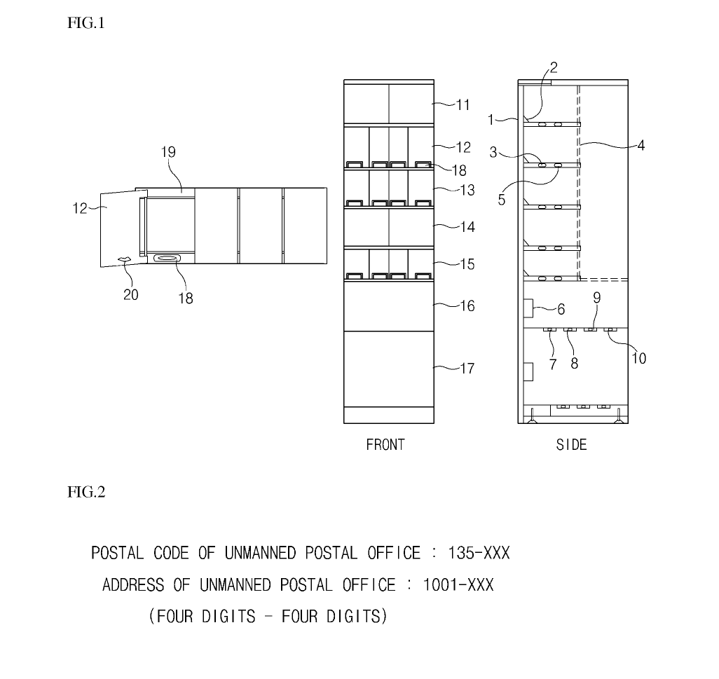

FIG. 1 is a view illustrating a delivery box which is provided in an unmanned postal office which is used in an unmanned postal mail delivering method according to an exemplary embodiment of the present invention. Referring to FIG. 1, an unmanned postal office includes a plurality of delivery boxes and the plurality of delivery boxes has various sizes to store delivered postal mails.

Specifically, the delivery boxes provided in the unmanned postal office are configured by a small flat rate box for a registered mail, a large flat rate box for a registered mail, and delivery boxes for every parcel size and configured to have the same height in two column units 11, 12; 13, 14; and 16, 17 so as to be easily reconfigured in accordance with space utilization of a delivery box and arrangement of the delivery box. For example, the small flat rate box and the large flat rate box for registered mail may be configured by four boxes 12 and 13 with a width of 50 cm. Further, devices 20 and 18 to automatically open or close a door of the delivery box may be provided at a lower portion or an upper portion of the delivery box. Further, when there are four delivery boxes and two or less delivery boxes located above or below the delivery boxes, a fixing frame 19 may be provided to fix a door of the four delivery boxes. That is, when the door of the four delivery boxes is open, the door is fixed so as not to be removed because the door is not fixed. A medium size parcel storage and a large size parcel storage are provided at a left side or a right side so that a door of the delivery box may be open or closed in one direction.

In order to identify a status when a postal mail is inserted into the delivery box or a presence of a postal mail in the delivery box, two or more sensors 3, 4, 7, 8, 9, and 10 may be provided in the delivery boxes. By doing this, two or more sensors 3, 4, 7, 8, 9, and 10 create identification information on whether to insert a postal mail into the delivery box or whether there is a postal mail and transmit the identification information to an integrated control system which integrally manages unmanned postal offices.

A partition 4 may be provided to adjust a depth of the delivery box by considering a maximum length of a postal mail to be delivered. By doing this, it is easy to identify a status indicating whether the postal mail is inserted into the delivery box when the postal mail is delivered and when a recipient of the postal mail receives the postal mail, it is easy to check the presence of the postal mail in the delivery box and receive the postal mail.

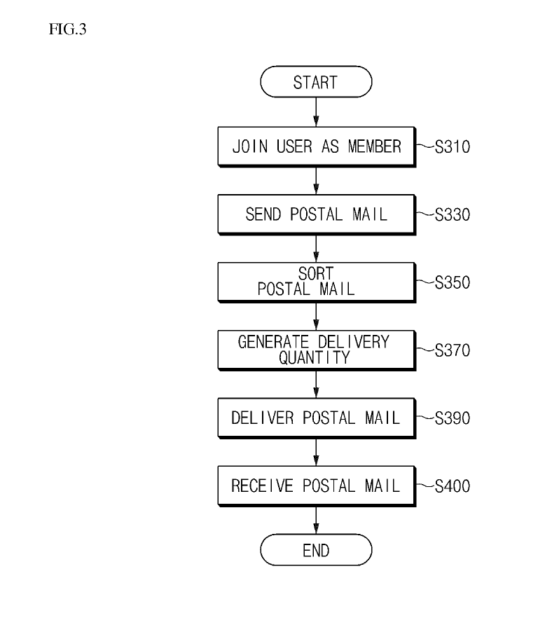

FIG. 2 is a view illustrating a postal code and an address of an unmanned postal office which is used in an unmanned postal mail delivering method according to an exemplary embodiment of the present invention. Referring to FIG. 2, the unmanned postal office is distinguished from other unmanned postal offices by a postal code and an address to be specified.

A method which is currently used in each country may be used for the postal code as it is. However, in the case of the address, a system which makes a postal mail sorting job for delivery of the postal mail easy may be applied. Specifically, an address of the unmanned postal office may be configured by “N digit integer−M digit integer” and N and M are natural numbers. First, the first N digit integer indicates a location number of a location where the unmanned postal office is provided and a control number and the last M digit integer indicates a membership number which is assigned to a sender who uses the unmanned postal office. In an example where N and M is 4, the first four-digit number indicates a collection and delivery zone of the postal mail and a location number of the unmanned postal office and the last four-digit number indicates a membership number. Such information may be used as information for inserting the postal mail when the postal mail is inserted into the delivery box of the unmanned postal office later.

When an address of an unmanned postal office in Gangnam of Seoul is “1001-0001”, Gangnam of Seoul is a name of a delivery region where the unmanned postal office is provided and the first four-digit number indicates the location in Gangnam of Seoul where the unmanned postal office is provided and serves as a control number of the unmanned postal office. The last four-digit number is the membership number and an order of a client who obtains an approval when a client joins as a member of an unmanned postal office system of the sender may be applied. When the sender of the unmanned postal office is a non-member who does not join as a member, an address which does not include the last four-digit number is used to accept the delivery of the postal mail. In this case, only the first four-digit number may be used as an address for delivering the postal mail to the unmanned postal office.

The postal code of the unmanned postal office may be set by a sender using a search result of the postal code and when the unmanned postal office is selected, the first four-digit number of the address of the unmanned postal office may be set to a value which is automatically created in accordance with an order of the unmanned postal office which is provided in the corresponding region and the address of the unmanned postal office may be registered in a postal code DB which is currently used in the country.

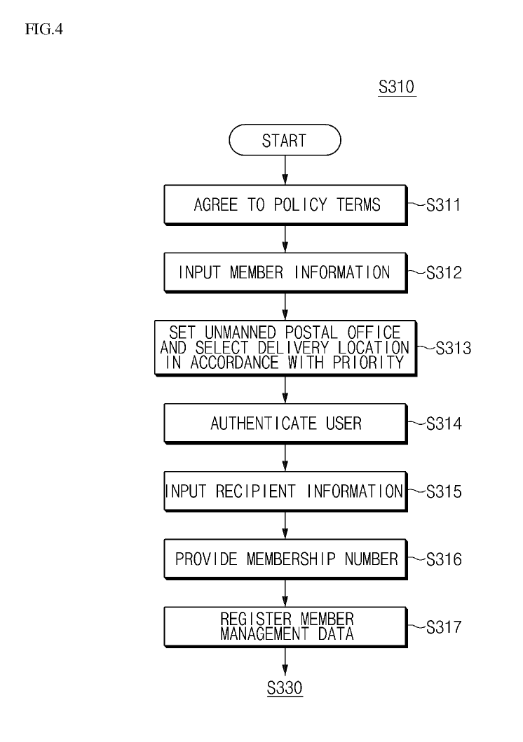

FIG. 3 is a view illustrating an unmanned postal mail delivering method according to an exemplary embodiment of the present invention. Referring to FIG. 3, an unmanned postal mail delivering method includes steps S310 to S400.

First, information on a sender who wants to send a postal mail to a delivery box provided in an unmanned postal office using an unmanned postal office system is obtained. Specifically, the information may be obtained when the sender joins as a member of the unmanned postal office system by him/herself in step S310.

Thereafter, information on a recipient who receives the postal mail is obtained through the sender. Further, a postal mail which is to be delivered to the unmanned postal office is specified through the address of the unmanned postal office and the postal code described above with reference to FIG. 2. After specifying the postal mail, the postal mail is sent to the postal office in step S330.

Thereafter, the postal mail which is sent and arrives at the postal office is sorted together with other postal mails which arrive at the postal office in step S350, through the address of step S320 and is included in a delivery quantity which will be delivered to an unmanned postal office which is set by the sender in step S370.

Thereafter, the postal mail is sorted and delivered to the unmanned postal office together with other postal mails which are included in the delivery quantity in step S390 and a recipient is authenticated whether to match a person which is set as a recipient of the postal mail, through the information on the recipient and when the recipient is successfully authenticated, the postal mail is received by the recipient in step S400.

FIG. 4 is a view specifically illustrating a member joining step of a sender of an unmanned postal mail delivering method according to an exemplary embodiment of the present invention. Referring to FIG. 4, a member joining step includes steps S311 to S317.

First, policy terms in which related regulations for using the unmanned postal office are described are provided to the sender and the sender is asked to agree to the provided policy terms in step S311.

Thereafter, information on the sender, such as an address of the sender and a number of a wireless terminal which is possessed by the sender, is input in step S312.

Thereafter, an unmanned postal office through which the postal mail can be received is set and a delivery location where the postal mail will be delivered when the postal mail is not delivered to the unmanned postal office is selected as another delivery location in step S313. Here, another delivery location may be one or more locations except for the unmanned postal office and when there are two or more delivery locations as another delivery location, priority may be assigned to the delivery locations.

Thereafter, the sender is authenticated based on the information on the sender which is input in step S312 (step S314).

Thereafter, information on a recipient of the postal mail is input in step S315. Here, similarly to the information of the sender, the information on the recipient includes a number of a wireless terminal which is possessed by the recipient and an e-mail address.

Thereafter, a membership number which allows the sender to use the wireless postal office system is assigned to the sender in step S316.

Thereafter, information and the membership number of the sender are registered as member data of senders who use the unmanned postal office in step S317.

During the member joining step of the unmanned postal office which is described above, terms of use of an unmanned postal office are provided through a configuration of registering and authenticating a member to acquire agreement of the sender and then an address of an unmanned postal office to which the postal mail is delivered and a postal code may be assigned by inputting an address of a recipient of the postal mail and an address searching/registering machine. When the number of members who use the unmanned postal office, a delivery quantity thereof, and a reception quantity are below a reference value, joining of the sender as a member is automatically approved. In contrast, when a quantity which may be processed by the unmanned postal office exceeds the reference value, an address and a postal code of another unmanned postal office which is close to the unmanned postal office may be provided to a user. Further, the sender may specify the recipient and family members including the recipient may be specified and registered as a recipient of the postal mail. When information thereof such as a number of a wireless terminal and an e-mail address is input, a message indicating a delivery status of the postal mail may be received through the wireless terminal and the e-mail.

When an available quantity of the delivery box of the unmanned postal office selected in step S313 exceeds a receivable quality, so that the postal mail cannot be delivered, another unmanned postal office or delivery location where the postal mail can be delivered may be registered and a storage date of the delivered postal mail, a request of extended storage, and a payment method when the extended storage is requested (a lump-sum payment or payment after reception at the time of extended storage) may be also provided to the sender. Not only the information of the sender, but also information on the recipient may be registered in member management data to be used.

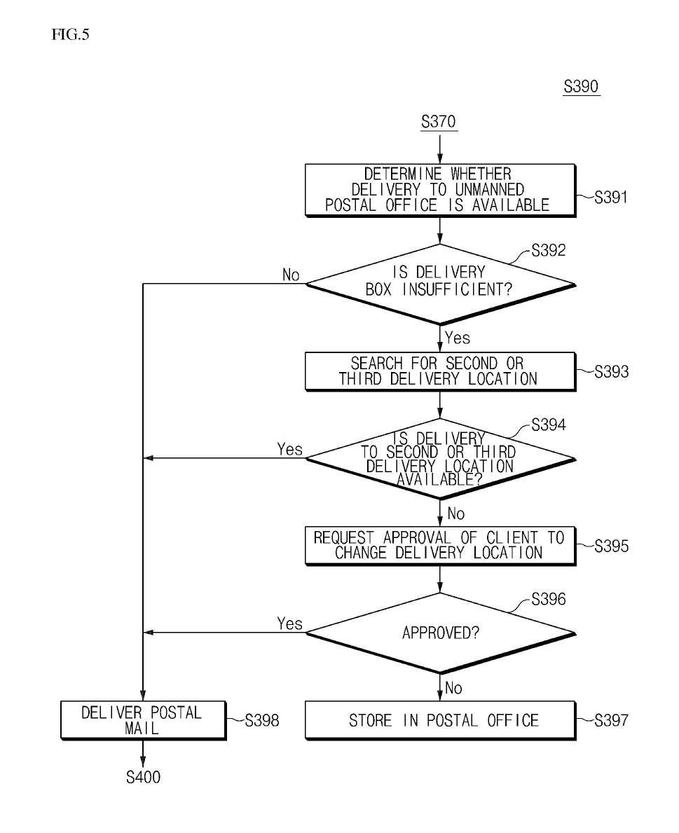

FIG. 5 is a view specifically illustrating a postal mail delivering step of an unmanned postal mail delivering method according to an exemplary embodiment of the present invention. Referring to FIG. 5, a postal mail delivering step includes steps S391 to S398.

First, a usage status of a delivery box provided in the unmanned postal office is checked to determine whether delivery of the postal mail to the unmanned postal office is available in step S391.

When the delivery of the postal mail to the unmanned postal office is available as a result of determining whether the delivery is available in step S391, the postal mail is delivered to the unmanned postal office in step S398. In contrast, the delivery of the postal mail to the unmanned postal office is unavailable, one or more other delivery locations (second or third delivery location) except for the unmanned postal office are checked in step S393.

Thereafter, it is determined whether the delivery of the postal mail to the other delivery location is available in step S394.

When the delivery of the postal mail to the other delivery location is available as a result of determining whether the delivery is available in step S394, the postal mail is delivered to the other delivery location in step S398. In contrast, the delivery of the postal mail to the other delivery location is unavailable, the recipient or the sender is asked to change the delivery location of the postal mail in step S395. Here, when the recipient or the sender is asked to change the delivery location of the postal mater, the recipient or the sender may be asked to change the delivery location of the postal mail through the wireless terminal which is possessed by the recipient or the sender or the e-mail.

Thereafter, the delivery location is changed through step S395, the postal mail is delivered to the changed delivery location, but when the delivery location is not changed, the postal mail is stored in a postal office where the postal mail is received first in order to use the unmanned postal office in step S397.

A delivery step which has been described above will be described in detail below.

When the postal mail to be delivered arrives at a postal office which manages an unmanned postal office to which the postal mail will be delivered, a registered mail barcode is read for every unmanned postal office or an automatic postal mail sorting job (for example, reading of a barcode of a membership number) may be performed. Thereafter, postal mails are aligned based on the first four-digit number of an address which specifies the unmanned postal office and a size of the postal mail according to a result of reading the registered mail barcode to create a delivery quantity which will be delivered to the unmanned postal office.

When delivery boxes are insufficient based on the size of the postal mail as a result of checking the usage status (a number of available delivery boxes in accordance with sizes of the delivery boxes) of the delivery boxes for every unmanned postal office, a postal mail which can be delivered is selected from the delivery quantity, by considering a condition of the size of the postal mail which can be delivered and a postal mail sorting job which determines whether the sender who sends the postal mail is a member or a non-member is performed, and then information for delivery is generated based on a registered mail barcode obtained during the postal mail sorting job and the reading result of the member information so that the delivery job is performed.

When the quantity of the postal mails which are delivered to the unmanned postal office is so large that the delivery cannot be made, the following process may be performed to deliver the postal mail to another unmanned postal office or another address of the recipient which is another delivery location requested by the sender.

A delivery condition of a postal mail which cannot be delivered is checked from member management data based on the membership number and when the second delivery region is the address of the recipient or a postal office, a delivery man in charge is selected and the registered mail barcode is read to generate delivery preparation data to transmit the result to a delivery preparation data managing machine which is provided in a postal operation management system.

In this case, when the postal mail is requested to be delivered to the delivery box of the unmanned postal office, a delivery box status of an unmanned postal office which is suitable for a delivery condition is checked from the delivery box managing machine and the delivery man reads or inputs the registered mail number of the postal mail or the membership number barcode by considering the size of the postal mail and the number of provided postal boxes to generate delivery information.

When the postal mail cannot be delivered to the second delivery location, the above-described processes are repeated to generate delivery information to deliver the postal mail to a third delivery location and then the postal mail is delivered to the third delivery location.

When a status of available delivery boxes in the unmanned postal office is checked and the number of available delivery boxes is smaller than a delivery quantity which will be delivered to the unmanned postal office, postal mails are aligned based on a postal mail reception order and data on a postal mail which cannot be delivered may be generated. In the meantime, delivery preparation completion data may be generated for a postal mail which can be delivered. Further, when the delivery to the third unmanned postal office cannot be made, the postal mail may be delivered to the address of the recipient or stored in the postal office.

When a delivery certificate described above is generated, it is notified to the sender or the recipient that the postal mail is ready to be delivered through an SMS, an E-mail, or a push message and as contents to be notified, contents which are created as one message for every recipient, rather than every postal mail to be delivered, may be transmitted. In order to efficiently sort the postal mail, a barcode which includes a membership number in the registered mailnumber may be used.

When the postal mail needs to be delivered to the second or third delivery location, the delivery job may be performed by identifying whether the postal mail can be delivered based on designated data, notifying that the postal mail cannot be delivered on the exact date in a region, to the sender or the recipient through the SMS, the E-mail, or the push message and checking whether the sender or the recipient wants to redeliver the postal mail the next day. In order to check the delivery location, the same method as a delivering method in accordance with a result of response of a client who is absent is applied and the postal mail may be delivered to the delivery location in accordance with a reply result of the client.

To this end, data of the sender or the recipient is checked to transmit a message for request of approval of the delivery location (a postal office or an address of the recipient) using a wireless terminal (for example, a cellular phone) and the delivery location may be determined by the result received correspondingly.

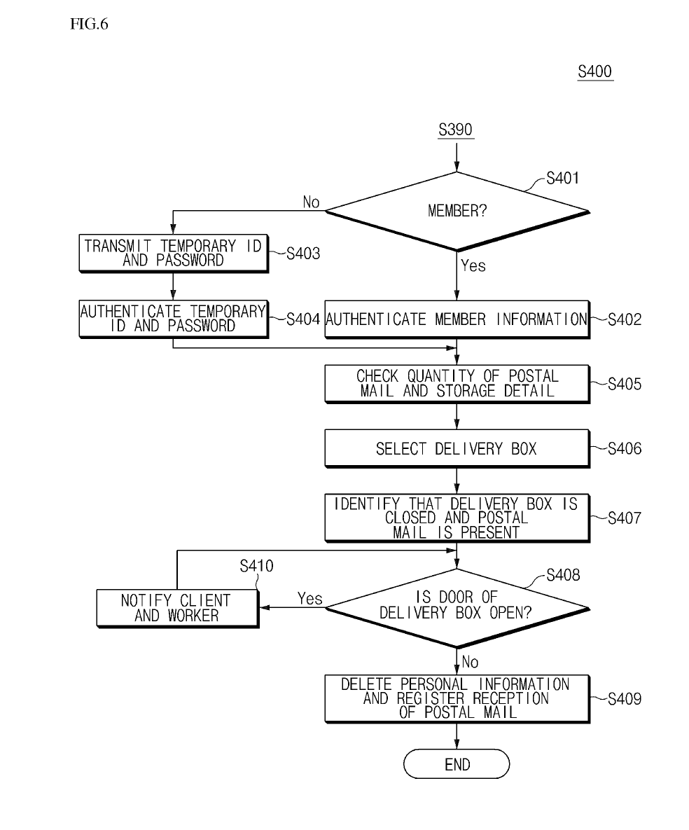

FIG. 6 is a view specifically illustrating a postal mail receiving step of an unmanned postal mail delivering method according to an exemplary embodiment of the present invention. Referring to FIG. 6, a postal mail receiving step includes steps S401 to S410.

First, it is determined whether a recipient who wants to receive the delivered postal mail is a member of the unmanned postal office system in step S401. Here, whether the recipient is a member may be determined by checking whether there is a membership number of the unmanned postal office.

As a result of the determination in step S401, when there is the membership number of the recipient and thus the recipient is a member, the recipient is authenticated through the membership number in step S402. In contrast, when there is no membership number of the recipient and thus the recipient is a non-member, temporary ID and password for receiving the postal mail are transmitted to the nonmember recipient in step S403 and the recipient is authenticated through the transmitted temporary ID and password in step S404.

Thereafter, a quantity of postal mails delivered to the delivery box of the unmanned postal office and a storage detail are checked. The quantity of the postal mails and the storage detail are provided to the recipient which is authenticated through an interface provided in the unmanned postal office.

Thereafter, the delivery box to which the postal mail is delivered is selected in accordance with the control of the recipient in step S406 and the postal mail is provided to the recipient.

Thereafter, it is identified whether a door provided on the selected delivery box is closed and whether other postal mail is present in the delivery box in addition to the received postal mail in step S407.

As an identifying result of step S407, when the door of the delivery box is closed, since the postal mail is safely received by an intended recipient, information on the sender and the recipient is deleted and information indicating that the postal mail is received by the recipient is stored in step S409.

In contrast, as an identifying result of step S407, when the door of the delivery box is not closed, it is notified to the recipient or a manager who manages the unmanned postal office that the door of the delivery box is open in step S410. Here, when other postal mail is present in the delivery box in addition to the received postal mail, the same operation is performed.

Step S410 will be described in more detail. When the door of the delivery box is opened, an additional notifying operation may be performed in accordance with a predetermined time. For example, even when three minutes which are previously set have elapsed after the recipient opens the door of the delivery box, when the door of the delivery box is still open, it is notified to the recipient that the door of the delivery box is open through the interface of the sender provided in the unmanned postal office. This is based on the assumption that the recipient may still be near the unmanned postal office for about three minutes.

Thereafter, when the door of the delivery box is still open after three minutes have passed and also five minutes which are previously set elapse, the recipient is notified that the door of the delivery box is open through the wireless terminal. That is, this is based on the assumption that the recipient may move away from the unmanned postal office after about five minutes.

Thereafter, when the door of the delivery box is still open after five minutes have passed and also ten minutes which are previously set elapse, it is notified to the manager who manages the unmanned postal office that the door of the delivery box is open. That is, after about ten minutes has elapsed, the delivery box is highly likely to be managed by the manager who manages the unmanned postal office rather than the recipient.

The postal mail receiving step which has been described above will be described in detail below.

When the recipient who receives the postal mail is a member or a nonmember, for example, the member is authenticated by inputting joining ID and password or when a membership barcode or card is recognized, membership data of a postal operation management system is checked to perform the authentication process. However, when the recipient is a nonmember, the temporary ID and password which are received through the cellular phone or the e-mail of the recipient who is a nonmember are compared with the temporary ID and password which are stored in an unmanned postal office operating and managing device and when the recipient is authenticated as a client who can receive the postal mail, a receiving method of a postal mail is provided to the recipient.

Thereafter, a list of postal mails which can be received is provided to a recipient who is completely authenticated. When the recipient selects the delivery box of the postal mail to be received and opens the delivery box, the door of the delivery box is automatically open through the integrated control system and the postal mail can be received.

Thereafter, when the door of the delivery box is closed by the recipient after the recipient receives the delivered postal mail, the door of the delivery box is identified to be closed and it is identified whether there is a postal mail in the delivery box. When there is no postal mail in the delivery box, a registered mail number connected to the delivery box is stored once the reception is completed. In the case of a delivery box where a plurality of postal mails is delivered, when one or more of a plurality of sensors provided in accordance with the size of the delivery box to precisely identify presence of the postal mail in the delivery box are identified to be on, it is identified that the postal mail is present in the delivery box.

Additionally, in order to precisely provide a postal mail reception quantity, when the recipient reads the registered mail barcode of the received postal mail using a barcode reader which is attached onto the delivery box, the postal mail with the read registered mailnumber is processed to be completely received and stored. Postal mails except for the registered mailnumber of the postal mail which has been delivered are still stored in the delivery box, and are registered in an operation result of the postal operation management system. In the meantime, when the recipient is a non-member, when it is checked that all the postal mails to be received have been received, the temporary ID and password which are transmitted to the non-member recipient are deleted.

A method for receiving a postal mail in a delivery box and a method for preventing a postal mail in a delivery box from being lost when the delivery box is not normally closed while receiving the postal mail will be described.

When only the postal mail is received from the delivery box during the receiving of the postal mail and the door of the delivery box is not yet closed after a predetermined time (three minutes which is a predetermined time), if it is identified that the postal mail is present by a result of detecting a postal mail in the delivery box, whether to continuously receive the postal mail is provided to the recipient through voice or a sender interface.

Thereafter, when the door is not closed (354) within five minutes or the postal mail is present in the delivery box, a message is transmitted to the phone number of the recipient to notify that there is a un-received postal mail. When the door of the delivery box is not closed after a predetermined time, the door of the delivery box needs to be closed by another recipient other than the recipient or the manager in order to progress a receiving job of other postal mails. That is, when the delivery box stays open, it may be notified to the manager that the door of the delivery box is open through the SMS message.

The unmanned postal mail delivering method according to an exemplary embodiment of the present invention may provide a value-added service related with the delivery of the postal mail together with the above-described steps. The sender or the recipient described above may request a value-added service such as extension of storage date of a postal mail which is delivered in the delivery box of the unmanned postal office, transmission of the postal mail to other place, return of the postal mail, and a postal mail image providing service.

The value-added service may be selected from a list of the postal mails which are provided to the sender or the recipient. Thereafter, when a storage date, a return request date, and a transmission request date which are input factors of the value-added service are input, payment for the value-added service is requested and the payment is made. For example, when the transmission service is requested, a service request detail including an input transmission address is registered and a payment method in accordance with a value-added service request detail may be registered as data. When a postal mail image searching service is selected, if a desired postal mail is selected, an image of the postal mail is provided on a screen and after checking the image of the postal mail, a necessary value-added service may be selected again. According to a value-added service for a postal mail whose storage date is extended, when the extended storage date expires because the client does not receive the postal mail, the client is notified that the storage date is terminated and when the client does not receive the postal mail thereafter, the postal mail may be switched as a target to be returned and a usage fee thereafter may be calculated and the payment detail may be provided to the recipient.

Specifically, when a collecting worker or a delivery worker logs-in in order to collect a postal mail which is requested by a sender to be delivered, the value-added service detail requested by the sender may be received from a value-added service managing machine to a value-added service processing result managing machine through the registered mail number of the postal mail to be stored.

When an output label related with the value-added service is attached onto a postal mail for which a value-added service selected by the client is requested and a read-out result of the registered mail barcode which is printed on the label is obtained, a result may be registered that the value-added service is completely received. When a result registered mail for a request service postal mail is completed, used information data may be deleted so as not to leak personal information. For the postal mail which is requested to be returned, a delivery box is selected and the registered mail barcode is read out by a barcode reader to register that the return process starts.

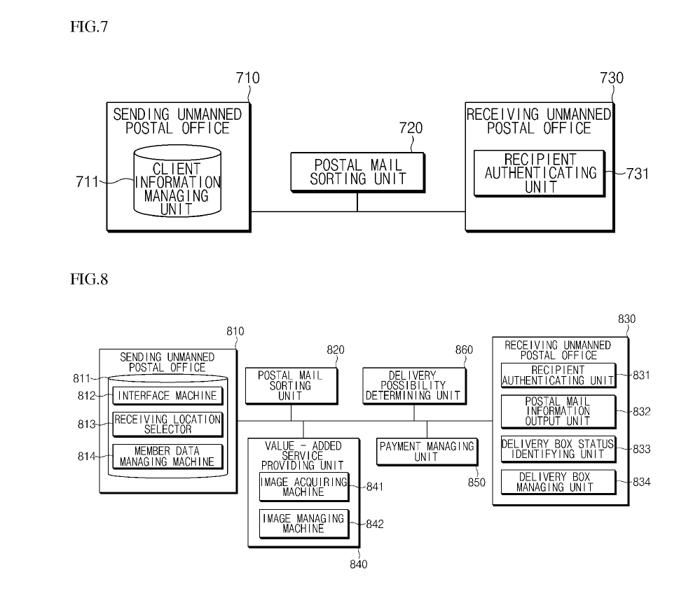

FIG. 7 is a view illustrating an unmanned postal mail delivering system according to another exemplary embodiment of the present invention. Referring to FIG. 7, an unmanned postal mail delivering system includes a client information managing unit 711, a postal mail sorting unit 720, and a recipient authenticating unit 731.

The client information managing unit 711 may be provided in a sending unmanned postal office 710 and receives, stores, and manages information such as a name or contact information of a sender of the postal mail and information such as a name or contact information of a recipient of the postal mail, and a reception location.

The postal mail sorting unit 720 distinguishes and specifies a postal mail which is requested through information of the recipient which is input from the client information managing unit 711 and an address of a sending unmanned postal office from other postal mails and aligns and sorts the postal mails in accordance with the sizes of the postal mails to generate a delivery quantity to be delivered to a receiving unmanned postal office.

The recipient authenticating unit 731 may be provided in the receiving unmanned postal office 730 and an identity of a person who receives the postal mail is authenticated through the input information on the recipient to determine whether the person is a true recipient of the postal mail.

Here, the recipient authenticating unit 731 determines whether there is a membership number of the receiving unmanned postal office of the recipient and when the membership number of the recipient is present, the recipient may be authenticated through the membership number. When there is no membership number of the recipient, a temporary ID and password are transmitted to the recipient to receive the postal mail and the recipient may be authenticated through the transmitted temporary ID and password.

FIG. 8 is a view specifically illustrating an unmanned postal mail delivering system according to another exemplary embodiment of the present invention.

The client information managing unit 811 may include an interface machine 812, a reception location selector 813, and a member data managing machine 814. The interface machine 812 provides policy terms to use a transmitting unmanned postal office from the sender to describe how to use the unmanned postal office and receives information on the sender and information on a recipient. The reception location selector 813 may select one or more other delivery locations except for the receiving unmanned postal office for preparation of a case when the delivery to the receiving unmanned postal office is not available. The member data managing machine 814 generates a membership number which distinguishes and specifies the sender who sends a postal mail, from other people and registers information on the sender and the membership number which are input through the interface machine 812 as membership data to manage senders who use the sending unmanned postal office.

The unmanned postal mail delivering system according to the exemplary embodiment of the present invention not only delivers the postal mail, but also provides a value-added service related with the postal mail to the sender or the recipient through a value-added service providing unit 840. Further, payment for providing the value-added service for which an additional fee is charged, among the value-added services is requested to the sender or the recipient through a payment managing unit 850 and the payment is processed. Here, the value-added service may include at least one of extension of storage date of a postal mail delivered in the delivery box of the receiving unmanned postal office, a request to transmit the postal mail to other delivery location, a request to return the postal mail, and a request to provide an image of the postal mail. The value-added service providing unit 840 may interwork with a wireless terminal of the sender or the recipient or the Internet and provide the value-added service to the requestor in accordance with a signal received from the interworking wireless terminal or Internet.

Specifically, in order to provide the image of the postal mail, the value-added service providing unit 840 may include an image acquiring machine 841 which acquires and stores an image of the postal mail and an image managing machine 842 which provides the image acquired in accordance with a request of the sender or the recipient to the sender or the recipient using wired or wireless communication.

The unmanned postal mail delivering system according to an exemplary embodiment of the present invention may include a delivery possibility determining unit 860. The delivery possibility determining unit 860 checks a usage status of a delivery box provided in a receiving unmanned postal office and determines the possibility of first delivery of the postal mail based on the checked result. When the first delivery is unavailable as a result of the determination, the delivery possibility determining unit 860 determines the possibility of a second delivery of the postal mail to another delivery location except for the receiving unmanned postal office.

In accordance with the determination result of the delivery possibility determining unit 860, when the first delivery of the postal mail is available, the postal mail sorting unit 820 sorts the postal mail as a delivery quantity of the receiving unmanned postal office. When the second delivery of the postal mail is available as a result of determining whether the second delivery is available, the postal mail sorting unit 820 sorts the postal mail as a delivery quantity of the other delivery location. When the second delivery of the postal mail is unavailable as a result of determining whether the second delivery is available, the postal mail sorting unit 820 may request the recipient or the sender to change a delivery location of the postal mail. When the delivery location is changed in accordance with the request, the postal mail is sorted as a delivery quantity of the changed delivery location and when the delivery location is not changed, the postal mail may be stored in a general postal office. Here, a request for changing the delivery location may be performed through the wireless terminal and the e-mail of the recipient or the sender.

The receiving unmanned postal office 830 may include a postal mail information output unit 832 and the postal mail information output unit 832 may provide a quantity of a postal mail stored and a storage detail to a recipient who is authenticated through the recipient authenticating unit 831.

The unmanned postal mail delivering system according to an exemplary embodiment of the present invention may further include a delivery box status identifying unit 833 and a delivery box managing unit 834. When the postal mail is received by the recipient, the delivery box status identifying unit 833 may determine whether a door of the delivery box where the postal mail is delivered is closed. Further, the delivery box status identifying unit 833 may identify whether other postal mails are present in addition to the postal mail. As a result of the identification of the delivery box status identifying unit 833, when the door of the delivery box is closed, the delivery box managing unit 834 determines that the postal mail is completely received and deletes information on the sender and the recipient and stores information indicating that the postal mail is received by the recipient. However, when the door of the delivery box is not closed, the delivery box managing unit 834 may notify the recipient or a manager who manages the unmanned postal office that the door of the delivery box is open.

When the door of the delivery box is not closed, the delivery box managing unit 834 may notify that the door of the delivery box is open through a recipient interface which is provided in the receiving unmanned postal office after a predetermined first time has passed. Thereafter, when the door of the delivery box is not yet closed, the delivery box managing unit 834 may notify the recipient that the door is open through the wireless terminal of the recipient after a predetermined second time has passed and notify the manager that the door is open after a predetermined third time has elapsed. Here, the first time, the second time, and the third time may be set in advance and among these, the first time is the shortest, the third time is the longest, and the second time may be between the first time and the third time.

As a result, according to the unmanned postal mail delivering method according to an exemplary embodiment of the present invention, an additional address system is applied to the unmanned postal office, so that the delivery preparation job is easy. Further, when a delivery box of the unmanned post office of the first delivery location is insufficient, the postal mail may be delivered to second and third unmanned postal offices or a delivery available address, so that the postal mail is less likely to be lost or stolen and utilization of the delivery box is maximized, thereby minimizing the installation space to minimize an installation cost.

Even though the present invention has been described through the specific exemplary embodiments, it may be appreciated that the present invention may be modified in various ways without departing from the scope. Therefore, the scope of the present invention is not limited to the above-described exemplary embodiments but may be determined by the following claims and equivalent thereto. Considering the above-described contents, when the change and modification of the present invention are included in the claims and a scope of equivalent thereto, it is considered that the present invention includes the change and the modification thereof.

What is claimed is:

1. An unmanned postal mail delivering method, comprising:
acquiring information of a sender who delivers a postal mail to a delivery box provided in a sending unmanned postal office;
specifying the postal mail through information on a recipient of the postal mail and an address of the sending unmanned postal office and sending the postal mail to the postal office;
sorting the postal mail together with a plurality of other postal mails of the postal office through the address to be included in a delivery quantity which will be delivered to a receiving unmanned postal office;
delivering the postal mail to the receiving unmanned postal office; and
receiving the postal mail by the recipient through authentication of information of the recipient.

2. The method of claim 1, wherein an address of the sending or receiving unmanned postal office is configured by “N digit integer−M digit integer” and N and M are natural numbers, the N digit integer indicates a location number of a location where the sending or receiving unmanned postal office is provided and a control number and the M digit integer indicates a membership number which is assigned to the sender in the acquiring of information of a sender.

3. The method of claim 1, wherein the acquiring of information of a sender includes:
requesting an agreement to policy terms for using the sending unmanned postal office to the sender;
inputting information of the sender:
setting the sending unmanned postal office and selecting one or more other delivery locations except for the receiving unmanned postal office;
authenticating the sender through the information of the sender;
acquiring information of a recipient of the postal mail;
providing a membership number which is assigned to the sender to the sender; and
registering the information of the sender and the membership number as membership data of senders who use the sending unmanned postal office.

4. The method of claim 1, wherein information of the sender and information of the recipient each include at least one of information of a wireless terminal which is possessed by the sender and the recipient and an e-mail address.

5. The method of claim 1, further comprising:
providing a value-added service related with the postal mail to the sender or the recipient; and
requesting payment for providing the value-added service,
wherein the value-added service includes at least one of extension of storage date of a postal mail delivered in the delivery box, a request to transmit the postal mail to another delivery location, a request to return the postal mail, and a request to provide an image of the postal mail.

6. The method of claim 1, wherein the delivering of the postal mail to the receiving unmanned postal office includes:
checking a usage status of a delivery box provided in the receiving unmanned postal office to determine whether first delivery of the postal mail is available;
delivering the postal mail to the receiving unmanned postal office when the postal mail can be delivered as a result of determining whether the first delivery is available and searching for one or more other delivery locations except for the receiving unmanned postal office when the delivery of the postal mail is unavailable;
determining whether a second delivery of the postal mail to the other delivery location is available;
delivering the postal mail to the other delivery location when the postal mail can be delivered as a result of determining whether the second delivery is available and requesting the recipient or the sender to change the delivery location of the postal mail when the delivery of the postal mail is unavailable; and
delivering the postal mail to the changed delivery location when the delivery location is changed and storing the postal mail in the postal office when the delivery location is not changed.

7. The method of claim 1, wherein the receiving of the postal mail by the recipient includes:
determining whether there is a membership number of the receiving unmanned postal office of the recipient;
authenticating the recipient through the membership number when there is a membership number of the recipient and transmitting temporary ID and password for receiving the postal mail to the recipient and authenticating the recipient through the temporary ID and password when the recipient does not have a membership number;
providing a quantity of the postal mail and a storage detail to the authenticated recipient; and
selecting the delivery box where the postal mail is delivered and providing the postal mail to the recipient.

8. The method of claim 7, further comprising:
after the receiving of the postal mail by the recipient,
identifying whether a door provided on the delivery box is closed and whether other postal mail is present in addition to the postal mail;
deleting the information of the sender and the recipient when the door of the delivery box is closed and storing information indicating that the postal mail is received by the recipient; and
notifying the recipient or a manager who manages the unmanned postal office that the door is open, when the door of the delivery box is not closed.

9. The method of claim 8, wherein the notifying that the door is open includes:
notifying that the door of the delivery box is open through a recipient interface which is provided in the receiving unmanned postal office after a predetermined first time has elapsed;
notifying the recipient that the door is open through a wireless terminal of the recipient after a predetermined second time has elapsed; and
notifying the manager that the door is open after a predetermined third time has elapsed, and
wherein among the first, second, and third times, the first time is the shortest time and the third time is the longest.

10. An unmanned postal mail delivering system, comprising:
a client information managing unit which is provided in a sending unmanned postal office and receives and manages information of a sender of a postal mail and information of a recipient of the postal mail;
a postal mail sorting unit which specifies the postal mail through information on the recipient of the postal mail and an address of the sending unmanned postal office and aligns and sorts the postal mails in accordance with a size of the postal mail to generate a delivery quantity which will be delivered to a receiving unmanned postal office; and
a recipient authenticating unit which is provided in the receiving unmanned postal office and authenticates whether to be the recipient of the postal mail through the information of the recipient.

11. The system of claim 10, wherein an address of the sending or receiving unmanned postal office is configured by “N digit integer−M digit integer” and N and M are natural numbers, and the N digit integer indicates a location number of a location where the sending or receiving unmanned postal office is provided and a control number and the M digit integer indicates a membership number which is assigned to the sender through the client information managing unit.

12. The system of claim 10, wherein the client information managing unit includes:
an interface machine which provides policy terms for using the sending unmanned postal office to the sender and receives the information of the sender and the information of the recipient;
a receiving location selector which selects one or more other delivery locations except for the receiving unmanned postal office; and
a member data managing machine which generates a membership number which specifies the sender and registers the information of the sender and the membership number as member data of the senders who use the sending unmanned postal office.

13. The system of claim 10, further comprising:
a value-added service providing unit which provides a value-added service related with the postal mail to the sender or the recipient; and
a payment managing unit which requests a payment for providing a value-added service for which a separate fee is charged among the value-added services and processes the payment,
wherein the value-added service includes at least one of extension of storage date of a postal mail delivered in the delivery box, a request to transmit the postal mail to another delivery location, a request to return the postal mail, and a request to provide an image of the postal mail.

14. The system of claim 13, wherein the value-added service providing unit includes:
an image acquiring machine which acquires and stores an image of the postal mail; and
an image managing machine which provides the image to the sender or the recipient using wired or wireless communication in accordance with the request of the sender or the recipient;

15. The system of claim 13, wherein the value-added service providing unit interworks with a wireless terminal of the sender or the recipient or the Internet and provides the value-added service in accordance with a signal received from the wireless terminal or Internet.

16. The system of claim 10, further comprising:
a delivery possibility determining unit which checks a usage status of a delivery box provided in the receiving unmanned postal office and determines the possibility of first delivery of the postal mail and when the first delivery is unavailable, determines the possibility of second delivery of the postal mail to another delivery location except for the receiving unmanned postal office,
wherein the postal mail sorting unit as a result of the determining of the possibility of the first delivery, when the first delivery of the postal mail is available, sorts the postal mail as a delivery quantity of the receiving unmanned postal office and as a result of the determining of the possibility of the second delivery, when the second delivery of the postal mail is available, sorts the postal mail as a delivery quantity of the other delivery location, and as a result of determining of the possibility of the second delivery, when the second delivery of the postal mail is unavailable, requests the recipient or the sender to change the delivery location of the postal mail, and when the delivery location is changed, sorts the postal mail as a delivery quantity of the changed delivery location and when the delivery location is not changed, sorts the postal mail as a storage quantity stored in the postal office.

17. The system of claim 16, wherein the postal mail sorting unit requests to change the delivery location of the postal mail through a wireless terminal and an e-mail of the recipient or the sender.

18. The system of claim 10, wherein the recipient authenticating unit further includes a postal mail information output unit which determines whether there is a membership number of the receiving unmanned postal office of the recipient, authenticates the recipient through the membership number when there is a membership number of the recipient and transmits temporary ID and password for receiving the postal mail to the recipient and authenticates the recipient through the temporary ID and password when the recipient does not have a membership number; and provides a quantity of the postal mails and a storage detail to the authenticated recipient.

19. The system of claim 18, further comprising:
after receiving of the postal mail by the recipient, a delivery box status identifying unit which identifies whether a door provided on the delivery box to which the postal mail is delivered is closed and whether other postal mail is present in addition to the postal mail; and
a delivery box managing unit which deletes the information of the sender and the recipient when the door of the delivery box is closed and stores information indicating that the postal mail is received by the recipient and notifies the recipient or a manager who manages the unmanned postal office that the door is open when the door of the delivery box is not closed.

20. The system of claim 19, wherein when the door of the delivery box is not closed, the delivery box managing unit notifies that the door of the delivery box is open through a recipient interface which is provided in the receiving unmanned postal office after a predetermined first time has elapsed; notifies the recipient that the door is open through a wireless terminal of the recipient after a predetermined second time has elapsed; and notifies the manager that the door is open after a predetermined third time has elapsed, and among the first, second, and third times, the first time is the shortest time and the third time is the longest.
